(19) United States
(12) Patent Application Publication
(10) Pub. No.: US 2004/0090781 A1
(43) Pub. Date: May 13, 2004

(54) Tool-free adjustable lamp fixture

(75) Inventor: Keat Hock Yeoh, Bayan Lepas (MY)

Correspondence Address: MARTINE & PENILLA, LLP, 710 LAKEWAY DRIVE, SUITE 170, SUNNYVALE, CA, 94085, US

(73) Assignee: IQ Group Sdn Bhd, Bayan Lepas (MY)

(21) Appl. No.: 10/632,465

(22) Filed: Aug. 1, 2003

(30) Foreign Application Priority Data
Nov. 13, 2002 (MY) PI 20024247

(51) Int. Cl. F21S 8/00

(52) U.S. Cl. 362/287; 362/427

(57) ABSTRACT

An adjustable lamp fixture comprises a mounting plate, at least an intermediate connector body, at least a lamp holder and a motion detection device. There are various mounting methods such as onto a wall or onto a ceiling. At least a first set of standard screw and spring mechanism engages the mounting plate with an open terminal end of the intermediate connector body. At least a second set of standard screw and spring mechanism engages one lateral end of the intermediate connector body linking one lamp holder. The standard screw and spring mechanism comprises a shoulder screw, a tower spring and a compression ring in that order. According to the invention, the rotation adjustment of the lamp fixture is facilitated about the first set of standard screw and spring mechanism, and the tilting adjustment of the lamp fixture is facilitated about the second set of standard screw and spring mechanism, the facilitation being substantially tool free.

### BACKGROUND OF THE INVENTION

1. Field of Invention

This invention relates to a tool-free adjustable lamp fixture, which can be selectively tilted or rotated from its installed position.

2. Description of the Related Art

A conventional lamp fixture carries at least one lamp and a motion detection device. The conventional lamp fixture may be installed in various mounting positions such as on wall or on ceiling. The fixture comprises a lamp holder, an intermediate joint body, and a wall plate. As seen in FIG. 1, a first end of the joint body is attached to the wall plate with the assistance of a lock nut. The lamp holder is attached to a side end of the joint body with the assistance of a wing nut laterally disposed. When a user wishes to adjust the position of the lamp fixture, the user needs to loosen the wing nut in order to achieve a tilting adjustment. Otherwise, the user needs to loosen the lock nut in order to achieve a rotational adjustment.

A tool such as a pliers and manual turning (by hand) are required to achieve the above adjustments. In the case of the lock nut, manual turning with certain amount of force may also be required. After the adjustment is made, a tool is again required to tighten the nut.

The conventional lamp fixture is installed at a mounting height of 2.5 m to 3.5 m. It is indeed not user-friendly as well as unsafe to a technician who has to climb up a ladder, and uses both hands to carry out the adjustments.

### SUMMARY OF THE INVENTION

The present invention has therefore as a primary object to improve the conventional lamp fixture, so that no hand tool is required for both rotational and tilting adjustments.

The above object is achieved in that a first set of standard screw and spring mechanism is applied to an open terminal end of an intermediate connector body, and a second set of standard screw and spring mechanism is applied to one lateral end of the intermediate connector body linking a lamp holder.

For rotational adjustment of the invention, a user simply rotates the fixture. For tilting adjustment, the user simply tilts the lamp holder to a desired position, and the lamp holder will be locked into position.

Another object of this invention is to provide a tool-free adjustable lamp fixture that is relatively simple and handy to be handled.

### BRIEF DESCRIPTION OF THE DRAWINGS

In order that the present invention may be more readily understood, the following description is given, by way of example, of one specific embodiment of a tool-free adjustable lamp fixture carrying two lamps and a motion detection device made in accordance with the present invention. Reference will be made to the accompanying drawings, in which:

FIG. 1 shows an isometric view of one embodiment of a conventional lamp fixture carrying two lamps and a motion detection device mounted on a wall.

FIG. 2a shows an isometric view of one embodiment of the present invention carrying two lamps and a motion detection device.

FIG. 2b shows an about-to-assemble partial view of various components making up the invention to a lamp holder.

FIG. 3a shows a partial side view of an intermediate connector body, in communication with a lamp holder, in a locked position.

FIG. 3b shows a partial side view of an intermediate connector body, in communication with a lamp holder when the lamp holder is being adjusted.

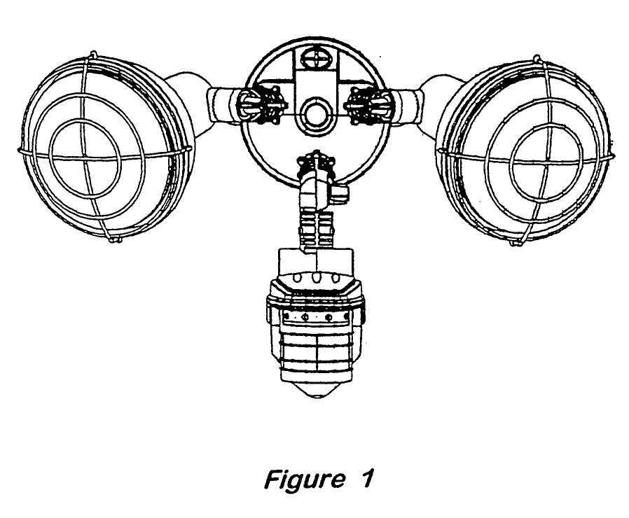

### DETAILED DESCRIPTION OF THE PREFERRED EMBODIMENTS

For ease of explanation, like numerals are used for similar components. Alphabets “a” and “b” are used to denote different sets of similar components in the invention.

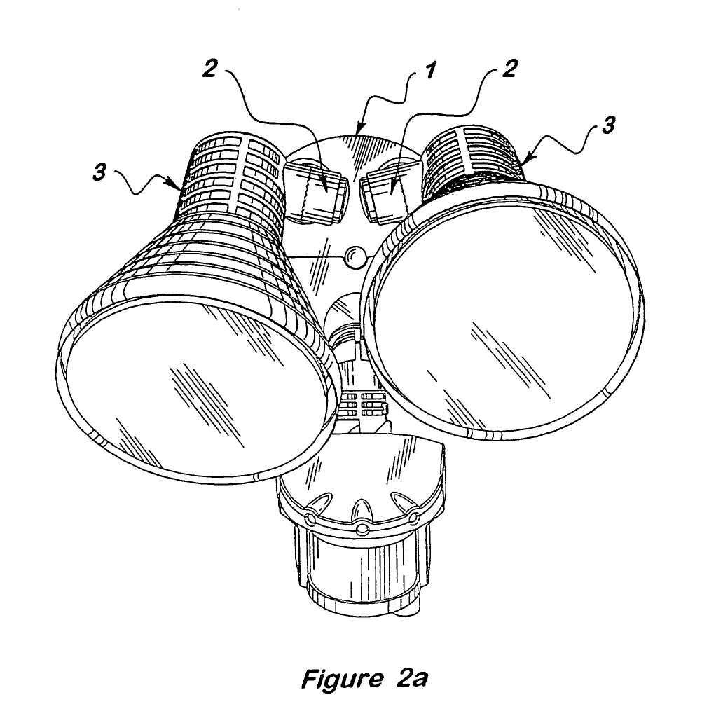

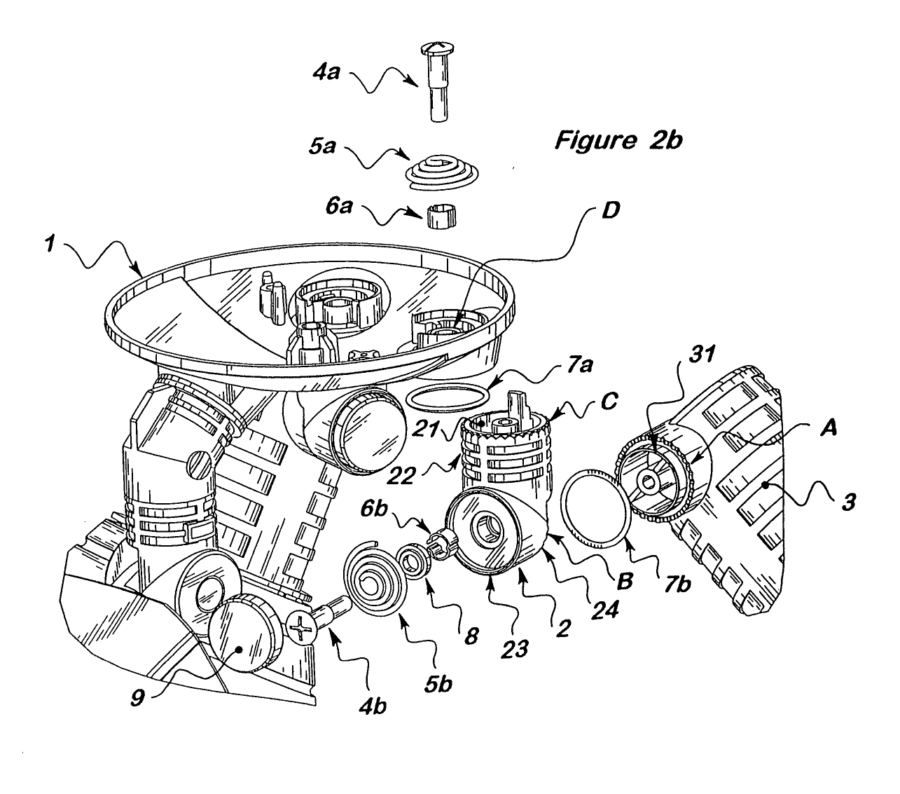

FIG. 2a shows one embodiment of the present invention with two lamps and one motion detection device. In FIG. 2b, an about-to-assemble view of various components to one lamp holder is shown. The invention comprises substantially a mounting plate (1), at least a first set of standard screw and spring mechanism (4a, 5a, and 6a), at least an intermediate connector body (2), at least a second set of standard screw and spring mechanism (4b, 5b, 6b), a motion detection device and at least a lamp holder (3). The first set of standard screw and spring mechanism (4a, 5a, 6a) is applied to one open terminal end (21) of the intermediate connector body (2) engaging the mounting plate (1), and the second set of standard screw and spring mechanism (4b, 5b, 6b) is applied to one lateral end (23) of the intermediate connector body (2) linking the lamp holder (3). The standard screw and spring mechanism comprises a shoulder screw (4), a tower spring (5) and a compression ring (6). The function of the compression rings (6a, 6b) in the two sets of screw and spring mechanisms is to provide an electrical earth-continuity from the mounting plate (1) through the intermediate connector body (2) to the lamp holder (3).

The intermediate connector body (2) is substantially cylindrical in shape. The open terminal end (21) is aligned with the central axis of the cylindrical connector body (22). The open terminal end (21) contains a receptor to receive the first shoulder screw (4a). The circumference of the open terminal end (21) of the intermediate connector body (2) is appropriately serrated as in a toothed gear (hereafter referred to as gear C). The adjacent portion of the mounting plate (1) is also appropriately serrated as in a toothed gear (hereafter referred to as gear D). The two gears C and D are meshed or mated with each other when the mounting plate (1) is engaged with the open terminal end (21). It is important to note that an O-ring (7a) is sandwiched between the open terminal end (21) of the intermediate connector body (2) and the mounting plate (1). The function of the O-ring (7a) is to provide a water seal to protect internal parts from water ingression.

Two lateral ends (23, 24) are provided on two sides of the intermediate connector body (2) on its other end. The lateral ends (23, 24) define a lateral axis which is at right angle to the central axis of the cylindrical connector body (22). A passageway traverses the two lateral ends (23, 24), so that a second shoulder screw (4b) is allowed to traverse from one lateral end (23) to the other lateral end (24) of the cylindrical connector body (22) adjoining a lamp holder (3). The circumference of one lateral end (24) of the intermediate connector body (2) is appropriately serrated as in a toothed gear (hereafter referred to as gear B). This serrated lateral end (24) will mesh or mate with a similarly serrated end (31) (hereafter referred to as gear A) on the lamp holder (3). This meshing or mating will prevent the lamp holder (3) from dislocating from its position. It is important to note that another O-ring (7b) is disposed in between the serrated lateral end (24) of the intermediate connector body (2) and the serrated end (31) of the lamp holder (3). The function of the O-ring (7b) is to provide a water seal to protect internal parts from water ingression.

The second set of screw and spring mechanism (4b, 5b, 6b) is installed to the un-serrated lateral end (23) of the intermediate connector body (2). A gasket (8) is disposed between the compression ring (6b) and the tower spring (5b). The function of the gasket (8) is to provide a water seal to protect internal parts from water ingression.

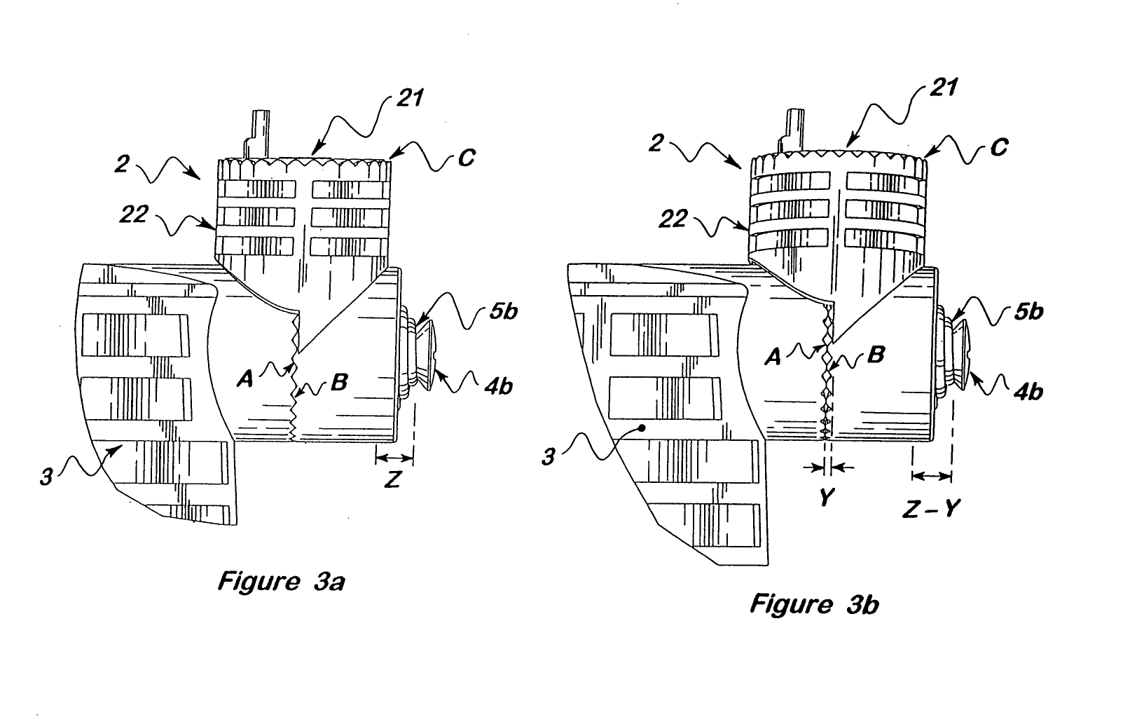

Referring to FIGS. 3a and 3b, the tilting adjustment can be explained. The second set of screw and spring mechanism (4b, 5b, 6b) is relied to facilitate a tilting adjustment. When an external force is applied to tilt the lamp holder (3), a rotational force is exerted between the lamp holder (3) and the intermediate connector body (2). The gear A at the lamp holder (3) and the gear B at the intermediate connector body (2) will move relative to each other. The second tower spring (5b) will compress and make way to allow the lamp holder (3) to tilt. When the external force is removed (i.e. the tilting action stops), the tower spring (5b) will relax and push the gear A and gear B (between the lamp holder (3) and the intermediate connector body (2)) to mate or mesh. The mating or meshing of the gear teeth or serrations (A and B) on the lamp holder (3) and the intermediate connector body (2) will prevent the lamp holder (3) from further change of position due to its weight. It also gives a ‘click’ feeling during the tilting adjustment. A screw cover (9) is employed to cover the second shoulder screw (4b).

When the invention is installed in normal position, the second shoulder screw (4b) is tightened until a pre-determined torque, which will produce adequate compression force onto the second tower spring (5b) and ensures that the gear A (on the lamp holder (3)) and the gear B (on the intermediate connector body (2)) shall mate or mesh properly peak to valley. The second tower spring (5b) characteristics shall be chosen, such that this compression force is sufficient to hold the intermediate connector body (2) and the lamp holder (3) with a lamp affixed. The lamp holder (3) is prevented from moving under its own weight. At this stage, the height of the second tower spring (5b) is denoted by dimension Z.

When an external force is applied to tilt the lamp holder (3), a rotational force is exerted between the lamp holder (3) and the intermediate connector body (2). The gear A at the lamp holder (3) and the gear B at the intermediate connector body (2) will move relative to each other. The peaks of gear A will slide up from the corresponding valleys of gear B, until the peaks of both gear A and gear B touch each other. This movement causes the lamp holder (3) to move downwards, and increases the compression force on the tower spring (5b). At this stage, the height of the tower spring (5b) is reduced to dimension Z minus dimension Y, where Y being the displacement of lamp holder (3) along the longitudinal axis of the shoulder screw (4b).

With further tilting force applied between the lamp holder (3) and the intermediate connector body (2), the peaks of gear A shall slide past the peaks of gear B. The compressed tower spring (5b) shall assist the movement until the peaks of gear A mate or mesh with the next valleys of gear B. This mechanism produces the characteristic ‘click’ feeling. The tower spring (5b) shall relax back to original compression state. If the tilting force ceases, then the tower spring (5b) together with the gears A and B shall hold the lamp holder (3) at that position relative to the intermediate connector body (2). If the tilting force continues to be exerted, then gear A will continue to roll over gear B from valley to valley, until the user is satisfied with the final position and then cease applying the tilting force.

The description above is for tilting adjustment, but the same mechanism is also applicable to rotational adjustment. The first set of screw and spring mechanism (4a, 5a, and 6a) engages the mounting plate (1) and the open terminal end (21) of the intermediate connector body (2). Essentially, the rotation of the lamp holder (3) is achieved about the axis of the first shoulder screw (4a). An O-ring (7a) is similarly employed, but no gasket is needed for this engagement. This is because the mounting plate (1) is mounted with the assistance of another gasket, hence the space inside the mounting plate (1) is already protected.

The tilting adjustment allows the lamp to be tilted up and down about the lateral end (24) of the intermediate connector body (2). The rotational adjustment allows the lamp to be rotated about the open terminal end (21) of the intermediate connector body (2).

What is claimed is:

1. An adjustable lamp fixture, comprising:
a mounting plate, at least an intermediate connector body, at least a lamp holder and a motion detection device, is characterised in which,
at least a first set of standard screw and spring mechanism engages the mounting plate with an open terminal end of the intermediate connector body;
at least a second set of standard screw and spring mechanism engages one lateral end of the intermediate connector body linking one lamp holder;
whereas the standard screw and spring mechanism comprises a shoulder screw, a tower spring and a compression ring,
whereby the rotation of the lamp fixture is facilitated about the first set of standard screw and spring mechanism, and the tilting of the lamp fixture is facilitated about the second set of standard screw and spring mechanism, the facilitation being substantially tool free.

2. A tool-free adjustable lamp fixture as in claim 1 in which the circumference of the open terminal end of the intermediate connector body is appropriately serrated as in a toothed gear (gear C), and the adjacent portion of the mounting plate is also appropriately serrated as in a toothed gear (gear D), the two gears (C and D) being meshed or mated with each other, all with the assistance of the first set of standard screw and spring mechanism.

3. A tool-free adjustable lamp fixture as in claim 1 in which the circumference of one lateral end of the intermediate connector body is serrated as in a toothed gear (gear B), and a side end of the lamp holder is serrated as in a toothed gear (gear A), the two gears (A and B) being meshed or mated with each other, whereas the second set of standard screw and spring mechanism provides sufficient compression force to counter the weight of the lamp holder and the lamp, so that the lamp holder remains in selected position.

4. A tool-free adjustable lamp fixture as in claim 1 in which the compression rings in the first and the second sets of standard screw and spring mechanism ensure electrical earth-continuity for various components.

5. A tool-free adjustable lamp fixture as in claim 1 in which an O-ring is sandwiched between the serrated lateral end of the intermediate connector body and the serrated end of the lamp holder.

6. A tool-free adjustable lamp fixture as in claim 1 in which an O-ring is sandwiched between the mounting plate and the serrated open terminal end of the intermediate connector body.

7. A tool-free adjustable lamp fixture as in claim 1 in which a gasket is sandwiched between the tower spring and the compression ring of the second set of standard screw and spring mechanism installed to the un-serrated lateral end of the intermediate connector body.
